(19) United States
(12) Patent Application Publication
(10) Pub. No.: US 2025/0235904 A1
(43) Pub. Date: Jul. 24, 2025

(54) DUAL SOURCE DRAIN CLEANERS INCLUDING ON DEVICE BATTERY CHARGING

(71) Applicant: Emerson Professional Tool, LLC, Elyria, OH (US)

(72) Inventors: Alex Michael Cole, Columbia Station, OH (US); Urmi Shah, Pune (IN); Abhishek Suhas Moghe, Pune (IN); Jeffrey Szucs, Ashland, OH (US)

(21) Appl. No.: 18/419,801

(22) Filed: Jan. 23, 2024

(51) Int. Cl. B08B 9/045; E03C 1/30; H02J 1/08; H02J 7/00; H02J 7/02

(52) U.S. Cl. CPC B08B 9/045; E03C 1/30; H02J 1/084; H02J 7/0063; H02J 7/0068; H02J 7/02; B08B 2209/04; H02J 2207/20

(57) ABSTRACT

Power tools, drain cleaners and methods are disclosed. A method of operating a power tool having a motor includes determining if the power tool is connected to a first power source, determining if the power tool is connected to a second power source, determining if an instruction to drive the motor is being received, powering the motor from the first power source when the instruction to drive the motor is being received and the power tool is connected to the first power source, and powering the motor from the second power source when the instruction to drive the motor is being received, the power tool is connected to the second power source, and the power tool is not connected to the first power source.

### FIELD

The field of the disclosure relates generally to drain cleaners and, more particularly, to drain cleaners having a dual power sources and the capability to charge a battery while it is installed on the drain cleaner.

### BACKGROUND

High speed drain cleaners include a flexible cable enclosed within a non-rotating sheath. The cable and sheath typically are positioned inside an annular channel of a drum. The drum rotates when the cable is pulled out from the drum. An electric motor is typically used to rotate the drain cleaning cable during drain cleaning operations.

Most known drain cleaners are powered by a single source-either an alternating current (AC) power source or a direct current (DC) battery. Some known drain cleaners are operable from a DC battery or a DC power supply plugged into the drain cleaner. Such systems are only operable by one of the two power sources (the DC battery or the DC power supply) and a mechanical lockout feature is often used to allow only one of the two sources to be attached to the drain cleaner at any time. Such known drain cleaners powered by batteries typically require an operator to remove the battery to charge it on a separate battery charger.

Some conventional high speed drain cleaners include a motor that rotates with the drum. In high speed drain cleaners that power the motor with a battery, the battery also rotates with the drum. It is difficult to access the battery in such conventional drain cleaners as various housing components secured by fasteners must be removed. The battery is often disposed behind a front cover that originates typical drain cleaner controls (e.g., on/off, forward/reverse) that must be removed to access the battery.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

One aspect of the present disclosure is a power tool device including a motor, a motor driver circuit coupled to the motor and configured to drive the motor with received power, and a power delivery circuit coupled to the motor driver circuit. The power delivery device includes a first input to receive power when the power tool is connected to a first power source, a second input to receive power when the power tool is connected to a second power source, a power output coupled to the motor driver circuit to selectively deliver power to the motor driver source, and a controller. The controller is programmed to determine if the power tool is connected to the first power source, determine if the power tool is connected to the second power source, receive an instruction to drive the motor, deliver power from the first power source to the motor driver circuit through the first input and the power output while the instruction to drive the motor is received and the power tool is connected to the first power source, deliver power from the second power source to the motor driver circuit through the second input and the power output while the instruction to drive the motor is received, the power tool is connected to the second power source, and the power tool is not connected to the first power source.

Another aspect of this disclosure is a method of operating a power tool including a motor, The method includes determining if the power tool is connected to a first power source, determining if the power tool is connected to a second power source, determining if an instruction to drive the motor is being received, powering the motor from the first power source when the instruction to drive the motor is being received and the power tool is connected to the first power source, and powering the motor from the second power source when the instruction to drive the motor is being received, the power tool is connected to the second power source, and the power tool is not connected to the first power source.

In another aspect of this disclosure, a drain cleaner includes a housing, a rotatable drum disposed in the housing; a motor secured to the drum for rotating a drain cleaning cable, a motor driver circuit coupled to the motor and configured to drive the motor with received power, and a power delivery device coupled to the motor driver circuit. The power delivery device includes a first input to receive power when the drain cleaner is connected to a first power source, a second input to receive power when the drain cleaner is connected to a second power source, a power output coupled to the motor driver circuit to selectively deliver power to the motor driver source, and a controller. The controller is programmed to determine if the drain cleaner is connected to the first power source, determine if the drain cleaner is connected to the second power source, receive an instruction to drive the motor, deliver power from the first power source to the motor driver circuit through the first input and the power output while the instruction to drive the motor is received and the drain cleaner is connected to the first power source, and deliver power from the second power source to the motor driver circuit through the second input and the power output while the instruction to drive the motor is received, the drain cleaner is connected to the second power source, and the drain cleaner is not connected to the first power source.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a perspective view of a drain cleaner;

FIG. 2 is another perspective view of the drain cleaner;

FIG. 3 is a cross-section of the drum and the drum housing of the drain cleaner;

FIG. 4 is a perspective view of the drain cleaner showing the housing chamber;

FIG. 5 is a front view of the drain cleaner showing the inner drum chamber;

FIG. 6 is an exploded view of the drain cleaning cable and a cleaning head of the drain cleaner;

FIG. 7 is a detailed perspective view of the drain cleaner showing the front housing segment chamber of the drain cleaner;

FIG. 8 is another cross-section of the drum and the drum housing of the drain cleaner;

FIG. 9 is a perspective view of a rotary slip ring of the drain cleaner;

FIG. 10 is a block diagram of the power components and sensors of the drain cleaner;

FIG. 11 is a front view of the cable clamp and temperature sensor of the drain cleaner;

FIG. 12 is a perspective view of a position sensor for sensing the position of the cable clamp; and

FIG. 13 is a perspective view of the drain cleaner showing the battery compartment.

Corresponding reference characters indicate corresponding parts throughout the drawings.

### DETAILED DESCRIPTION

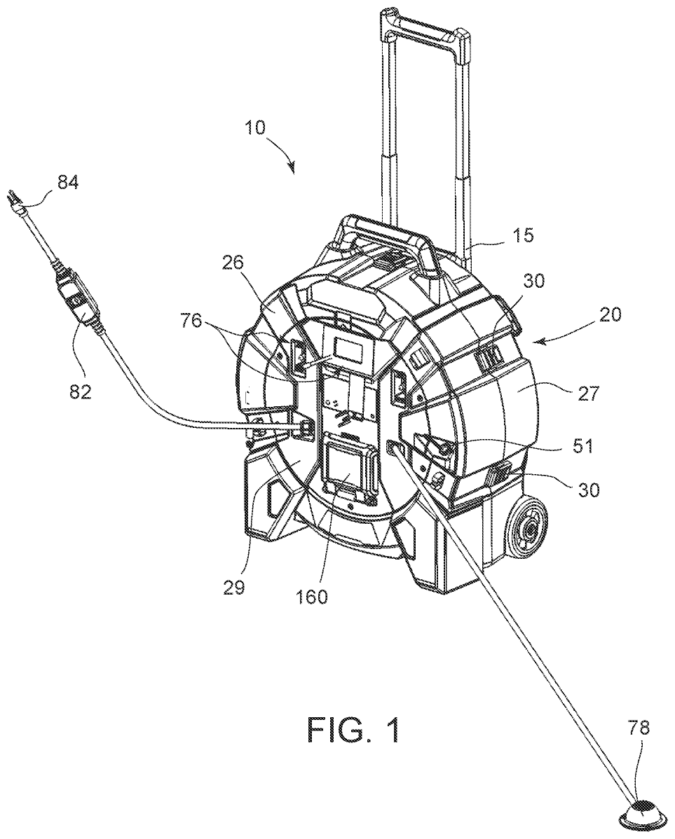

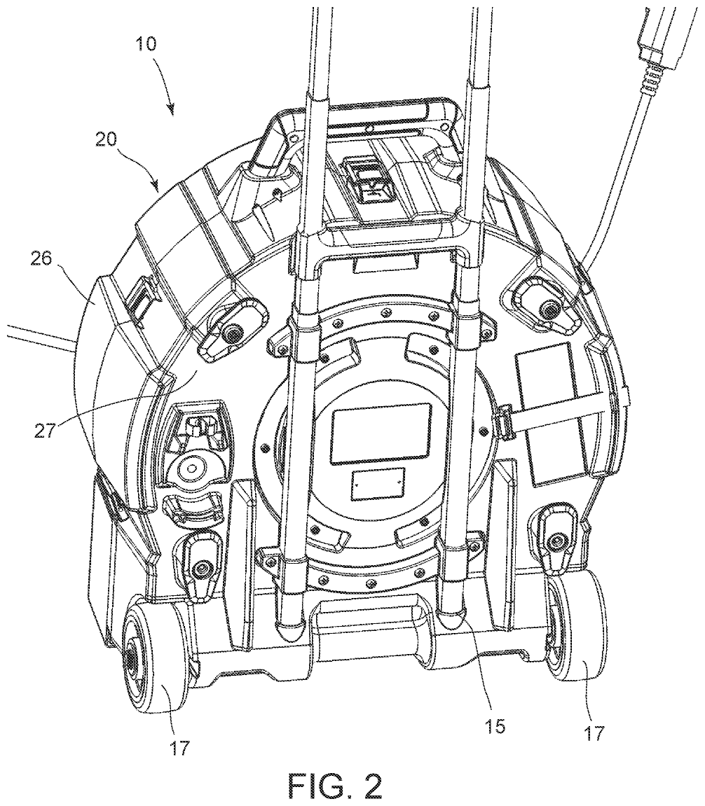

An embodiment of a drain cleaner 10 is shown in FIGS. 1-13. The drain cleaner 10 is shown in a vertical orientation and includes an optional cart 15. The drain cleaner 10 is selectively attachable, detachable, and/or releasable from the cart 15. The drain cleaner 10 includes at least one wheel 17 (FIG. 2) and typically utilizes two, four or six wheels. The drain cleaner 10 is typically operated in a horizontal orientation (e.g., may include a bearing that accommodates axial loads when the drain cleaner 10 is operated in a horizontal orientation). The drain cleaner 10 may include features and components disclosed in U.S. Patent Publication No. 2021/0172162, which is incorporated herein by reference for all relevant and consistent purposes.

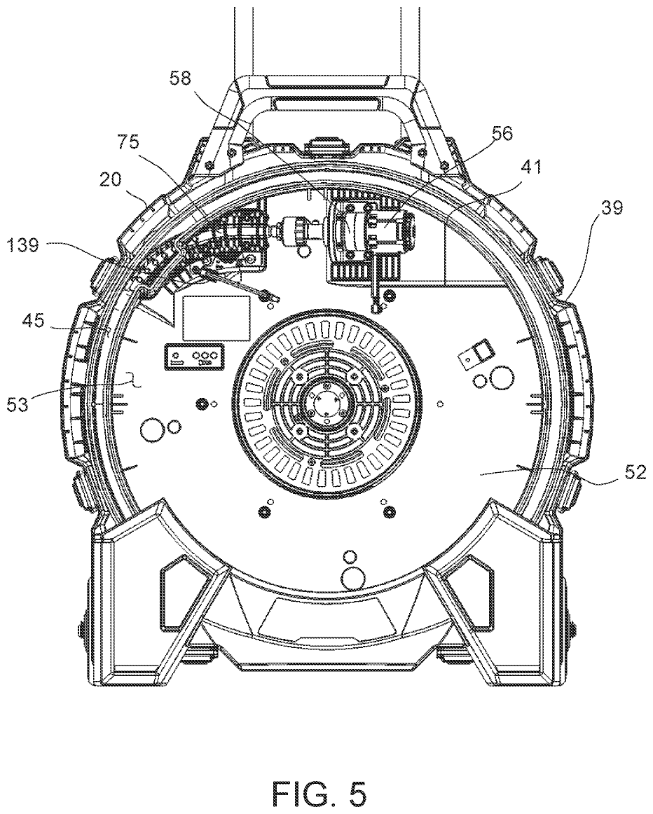

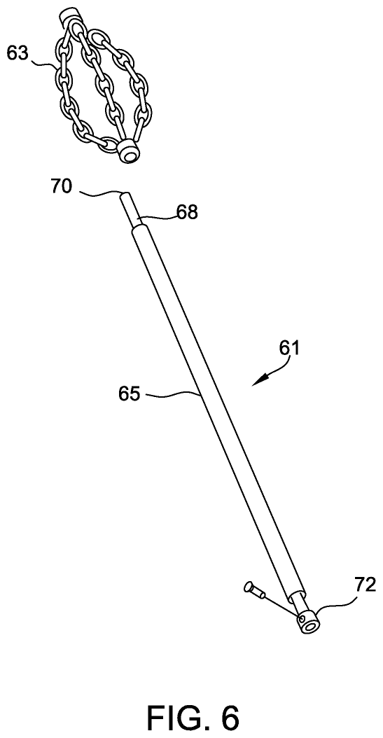

The drain cleaner 10 operates by rotating a cleaning head 63 (FIG. 6) as the cleaning head 63 moves through a drain. In the illustrated embodiment, the cleaning head 63 is connected to a drain cleaning cable 61 that includes a sheath 65 and a cable 68 positioned within the sheath 65. The cable 68 rotates relative to the sheath 65. The cable 68 connects to the cleaning head 63 at a distal end 70 of the cable 68. The cable 68 also connects to the output of a gear box 58 (FIG. 5) at a proximal end 72 of the cable 68. While the present disclosure describes a drain cleaning cable having a cable that rotates within a sheath, other types of drain cleaning cables could be used.

The drain cleaner 10 includes a drum housing 20 (FIG. 1). The drum housing 20 is generally cylindrical. The drum housing 20 includes a front housing segment 26 and a rear housing segment 27. The front housing segment 26 includes a front segment housing cover 29. The front housing segment 26 is removably connected to the rear housing segment 27 by latches 30,

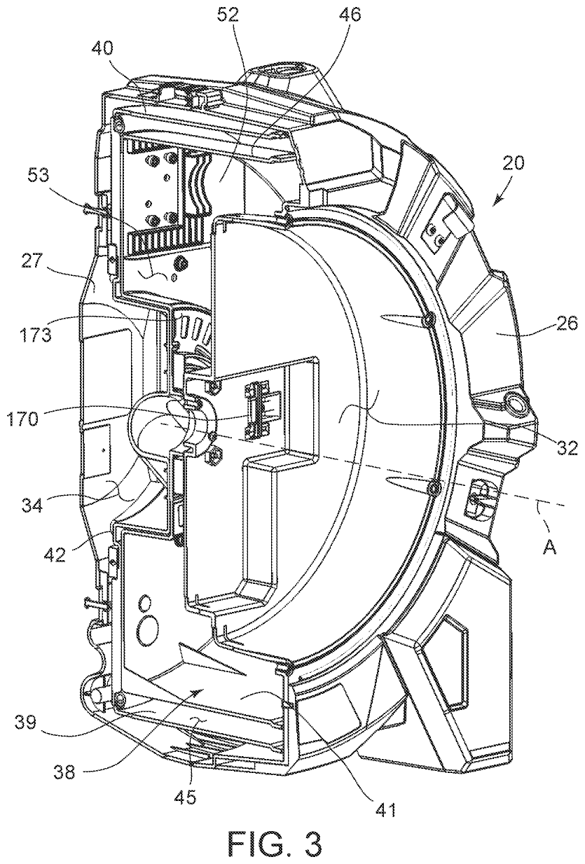

The cover 29 encloses a front housing segment chamber 32 (FIG. 3) in which a various electronic components (e.g., motor controller and internal power supply) are disposed. The front housing segment 26 and the rear housing segment 27 form a housing chamber 34 in which a rotatable drum 38 is disposed.

The rotatable drum 38 includes an outer drum 39 and an inner drum 41 disposed within the outer drum 39. The inner drum 41 and outer drum 39 are rotatable relative to the drum housing 20 and rotate about axis A. The outer drum 39 and inner drum 41 are both cylindrically shaped. The inner drum 41 is concentrically positioned within the outer drum 39, The outer drum 39 and the inner drum 41 form an annular drum channel 45 for receiving the drain cleaning cable 61 (FIG. 6). The drain cleaning cable 61 is disposed within the annular drum channel 45 and moves in and out of the drum housing 20 (FIG. 1) as the inner drum 41 and outer drum 39 rotate. The drum housing 20 includes a cable port 51 through which the cable passes during cleaning operations of the drain cleaner 10,

The drain cleaner 10 may include drum support assemblies (not shown) that support the outer drum 39 and inner drum 41 and may include a bearing (e.g., bearing) disposed between the primary and secondary support assemblies that enables the drum 38 to rotate relative to the housing 20.

The outer drum 39 includes an annular partition 40 and a basewall 42 that extends radially inward from the annular partition 40 toward the axis of rotation A of the inner drum 41. The inner drum 41 includes an annular partition 46 and a basewall 52 that extends radially inward from the annular partition 46 toward the axis of rotation A of the inner drum 41. The inner drum 41 defines an inner drum chamber 53 in which various components that rotate with the inner drum 41 are disposed.

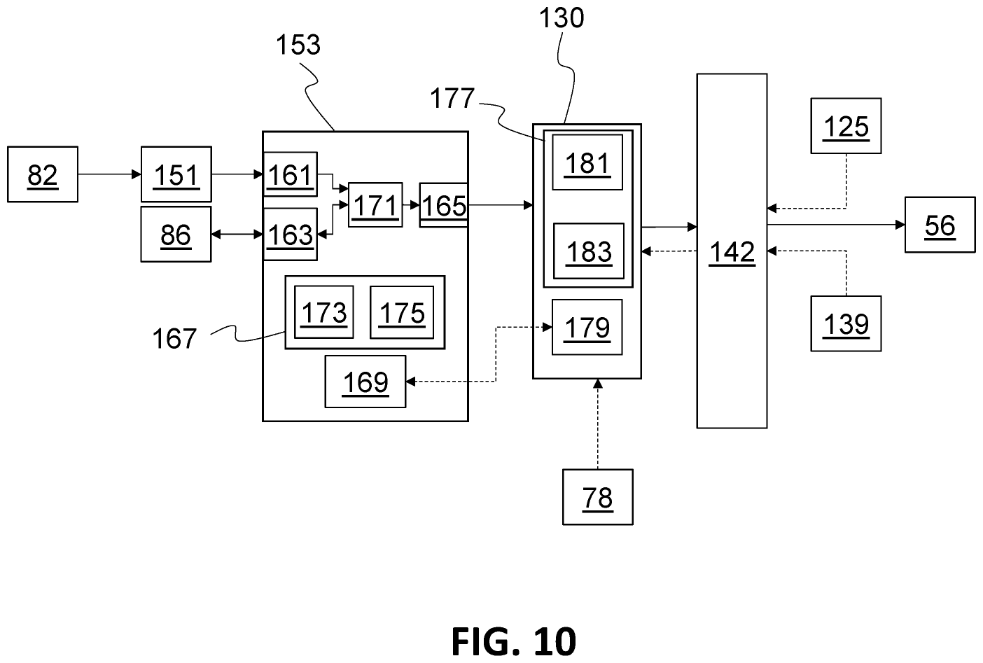

Referring now to FIG. 5, the drain cleaner 10 includes an electric motor 56 secured to the inner drum 41 and disposed within the inner drum chamber 53. The motor 56 rotates with the inner drum 41. In some embodiments, the drain cleaner 10 may include a counterweight secured to the inner drum 41 and disposed within the inner drum chamber 53. The drain cleaner 10 includes a gear box 58 connected to the motor 56 (e.g., connected to a rotary output of the motor 56). The gear box 58 rotates with the inner drum 41. The motor 56 may be controlled by a motor controller 130 (FIG. 10; sometimes also referred to as a motor driver circuit) as discussed further below. The motor controller 130 is stationary (does not rotate with the drum 38) and may be disposed in the front housing segment chamber 32 (FIG. 3).

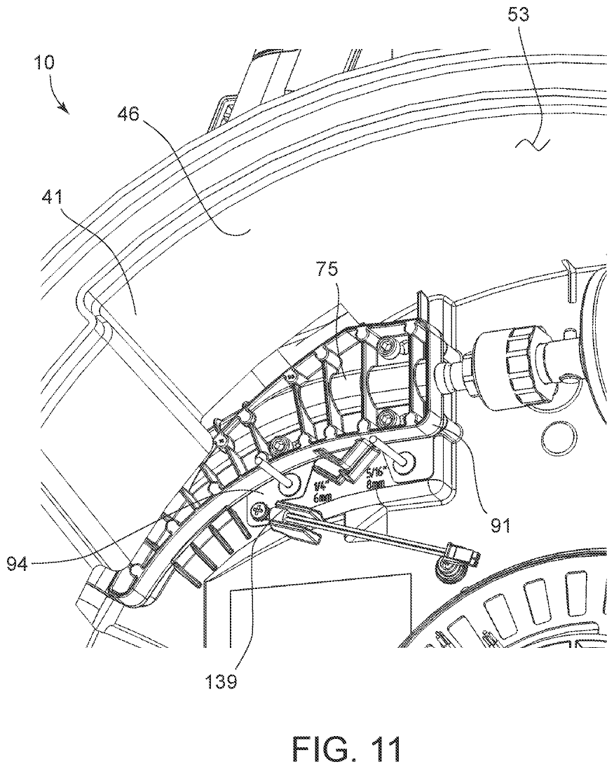

The drain cleaner 10 includes a cable clamp 75 (FIG. 11) secured to the inner drum 41 and disposed within the inner drum chamber 53. The cable clamp 75 is positioned over at least a region or portion of the drain cleaning cable 61 (FIG. 6). The cable clamp 75 rotates with the inner drum 41. The cable clamp 75 includes a main body 91 and a shield plate 94 disposed below the main body 91 which the cable being clamped between the main body 91 and shield plate 94.

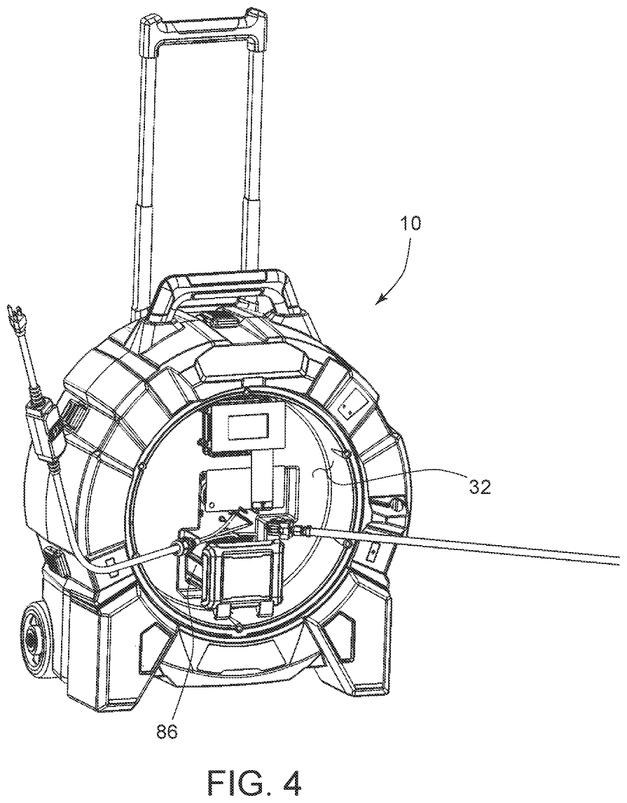

The drain cleaner 10 includes various controls and/or indicators 76 (FIG. 1). Specifically, the controls and indicators 76 can include one or more selector switches and electrical circuit breakers. The drain cleaner 10 may also optionally include a foot operated switch 78 for governing operation of the drain cleaner 10. The drain cleaner 10 includes components and circuitry for signal and/or power delivery between the housing cover 29 and the motor 56. (FIG. 5). The drain cleaner 10 is connectable to a first power source to receive power to operate the drain cleaner 10 and to power the motor 56. In the example embodiment, the first power source is an alternating current (AC) power source, such as mains power. The drain cleaner 10 includes a power cord assembly 82 having a plug 84 to connect the drain cleaner to mains power. The drain cleaner 10 is also connectable to a second power source, such as a direct current (DC) power source, to receive power from the second power source to operate the drain cleaner 10 and to power the motor 56. In the example embodiment, the DC power source is a battery 86 (FIG. 4). The motor 56 is selectively powered (e.g., as determined by a controller as discussed below) by mains power or by the battery. The power cord assembly 82 also includes one or more switches and ground fault circuit interrupter (GFCI).

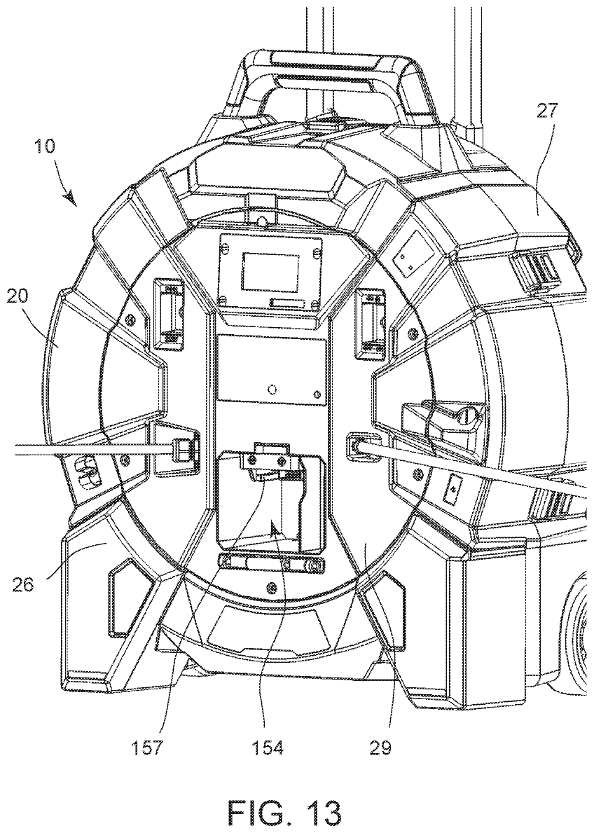

The battery 86 (FIG. 4) is stationary relative to the drum 38 (FIG. 3) and relative to the components that rotate with the drum 38. For example, the motor 56 (FIG. 5) rotates relative to the battery 86. In the illustrated embodiment, the battery 86 is external to the inner drum chamber 53 (FIG. 5), The battery 86 is removably disposed in a battery compartment 154 (FIG. 13) defined by the housing 20 and, in particular, the front housing segment 26. The battery compartment 154 is disposed in the housing chamber 34 (FIG. 3). The battery 86 is removably connected to the housing 20 by rails 157. The battery 86 may be enclosed in the battery compartment 154 by a removeable cover 160 (FIG. 1) which is hingedly connected to the housing 20. The battery 86 may be a rechargeable 18 volt battery (e.g., lithium ion),

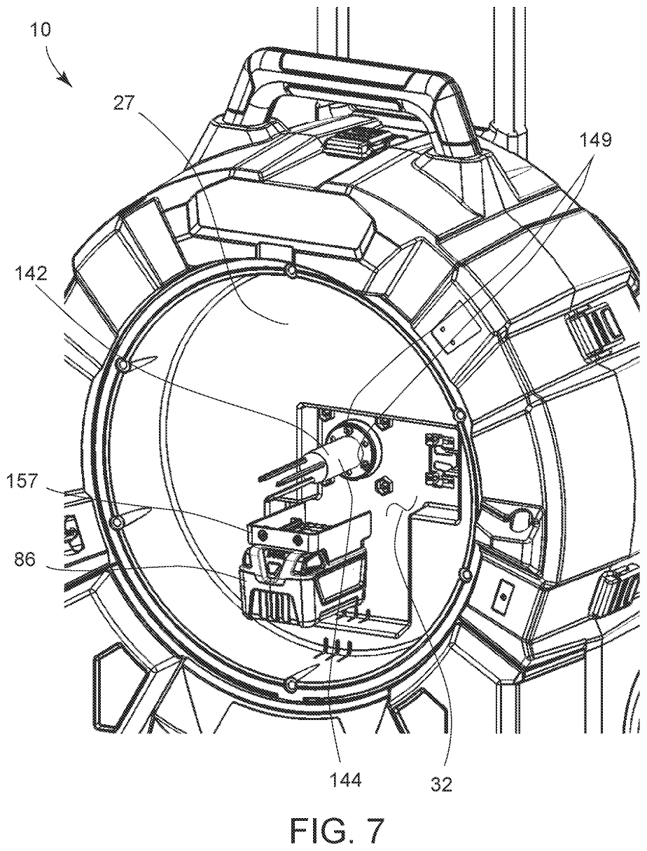

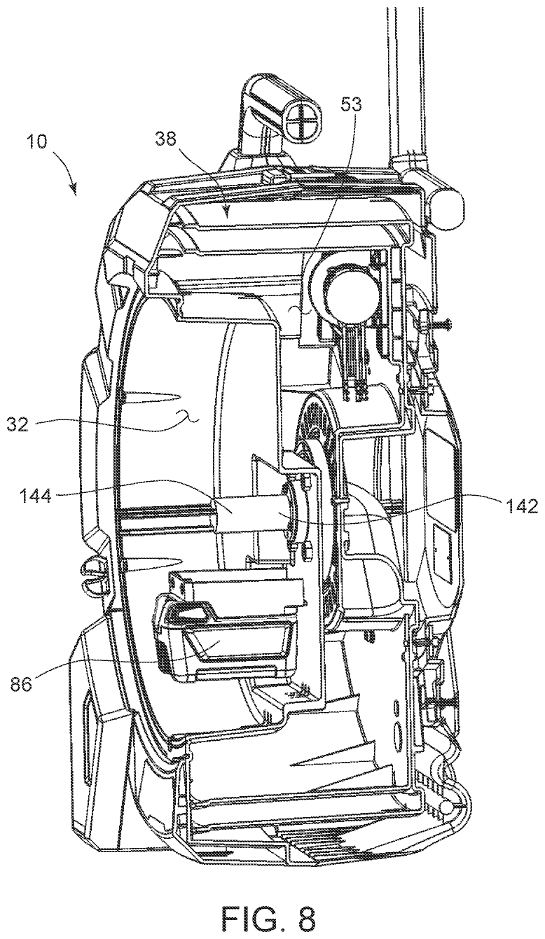

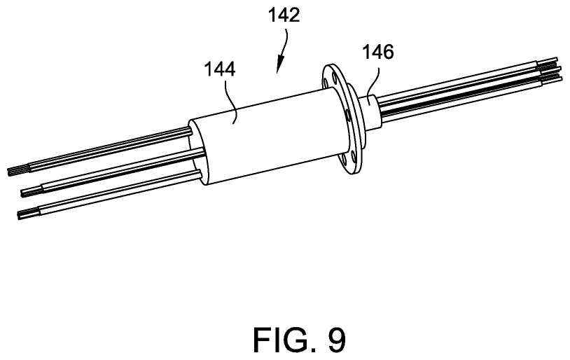

Referring now to FIGS. 7-9, the motor 56 (FIG. 5) is powered from the battery 86 or from mains power through a rotary slip ring 142. The rotary slip ring 142 includes a first portion 144 that is disposed within the front housing segment chamber 32 and a second portion 146 (FIG. 9) that is disposed in the inner drum chamber 53 (FIG. 8). The second portion 146 rotates relative to the first portion 144 and rotates with the drum 38. The first portion 144 is connected to the front housing segment 26 by fasteners 149.

The rotary slip ring 142 may include a number of electronically conductive spring-biased contacts within the first portion 144. The spring-biased contacts contact an electrically conductive cylinder that rotates with the first portion 144. The cylinder includes a series of grooves with each groove being connected to electrical wiring (e.g., for transfer of power or a communication signal). As the cylinder rotates, the conductive grooves contact the stationary contacts for transfer of power and signals between the stationary and rotating components of the drain cleaner 10.

With reference now primarily to FIG. 10, the drain cleaner 10 includes an internal power supply 151 or more simply “power supply” which is configured to supply DC power to the motor 56 from the first power source. In FIG. 10, solid arrows indicate electrical power connections and dashed arrows represent communications and/or signals connections. The power supply 151 is an AC to DC (AC/DC) converter that is configured to receive AC power and output DC power. In the example embodiment, the power supply 151 is a step-down AC/DC isolated power converter. Other embodiments may use any other suitable AC/DC power converter. The power cord assembly 82 is connected to the power supply 151 and supplies AC power to the power supply 151. The power supply 151 converts AC power to a DC power output.

The drain cleaner 10 includes to a power delivery device 153. The power delivery device includes a first input 161, a second input 163, a power output 165, a controller 167, a communication interface 169, and charging and switching circuitry 171. Generally, the power delivery device 153 determines whether to deliver power from the first or second power source to the motor controller 130 and handles charging of the battery 86. In the example, the power delivery device includes a printed circuit board assembly (PCBA), but other constructions may be used. The DC power output from the power supply 151 is provided to the first input 161 of the power delivery device 153. The battery 86 connects to the second input 163 of the power delivery device 153. The power output 165 of the power delivery device 153 is connected to a motor controller 130 to provide power to the motor controller.

The controller 167 generally includes any suitable computer and/or other processing unit, including any suitable combination of computers, processing units and/or the like that may be communicatively connected to one another and that may be operated independently or in connection within one another (e.g., controller 167 may form all or part of a controller network). Controller 167 may include one or more modules or devices, one or more of which is enclosed within the drain cleaner 10, or may be located remote from the drain cleaner 10. The controller 167 includes a processor 173 and a memory 175. The memory 175 stores instructions that, when executed by the processor 173, program (or configure) the controller 167 to perform a number of computer-implemented functions, including controlling delivery of power to the motor controller 130 and charging the battery 86 as described herein. Although a single processor 173 and memory 175 are illustrated, the controller 167 may include more than one of each component and may include additional components.

As used herein, the term “processor” refers not only to integrated circuits, but also refers to a controller, a microcontroller, a microcomputer, a programmable logic controller (PLC), an application specific integrated circuit, and other programmable circuits. Additionally, memory 175 of controller 167 may generally be or include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements.

The communication interface 169 enables the controller 167 to communicate with remote devices and systems, including the motor controller 130. The communication interface 169 may be a wired or wireless communications interface that permits the controller to communicate with the remote devices and systems directly or via a network. Wireless communication interfaces may include a radio frequency (RF) transceiver, a Bluetooth® adapter, a Wi-Fi transceiver, a ZigBee® transceiver, an infrared (IR) transceiver, a near field communication (NFC) transceiver, and/or any other device and communication protocol for wireless communication. (Bluetooth is a registered trademark of Bluetooth Special Interest Group of Kirkland, Washington; ZigBee is a registered trademark of the ZigBee Alliance of San Ramon, California.) Wired communication interfaces may use any suitable wired communication protocol for direct communication including, without limitation, USB, RS232, I2C, SPI, analog, and proprietary I/O protocols.

In some embodiments, the wired communication interface 169 may include a wired network adapter allowing the computing device to be coupled to a network, such as the Internet, a local area network (LAN), a wide area network (WAN), a mesh network, and/or any other network to communicate with remote devices and systems via the network. Although shown as a separate component, the communication interface 169 may be part of the controller 167 in some embodiments.

The charging and switching circuitry 171 delivers (e.g., switches) power from the first source or the second source received through the first input 161 or the second input 163 to the power output 165 as instructed by the controller 167. The charging and switching circuitry 171 also charges the battery 86 through the second input (which may also be reference to as an input/output) using power from the first power source received through the first input 161 as instructed by the controller 167. Operation of the charging and selection of the which power source to use to provide power to the motor controller 130 will be discussed in more detail below.

The motor controller 130 includes a controller 177 and a communication interface 179. The controller 177 generally includes any suitable computer and/or other processing unit, including any suitable combination of computers, processing units and/or the like that may be communicatively connected to one another and that may be operated independently or in connection within one another (e.g., controller 177 may form all or part of a controller network). Controller 177 may include one or more modules or devices, one or more of which is enclosed within the drain cleaner 10, or may be located remote from the drain cleaner 10. The controller 177 includes a processor 181 and a memory 183. The memory 183 stores instructions that, when executed by the processor 181, program (or configure) the controller 177 to perform a number of computer-implemented functions, including determining when to operate the motor 56 and controlling delivery of power to the motor 56 to drive the motor. Although a single processor 181 and memory 183 are illustrated, the controller 177 may include more than one of each component and may include additional components.

As used herein, the term “processor” refers not only to integrated circuits, but also refers to a controller, a microcontroller, a microcomputer, a programmable logic controller (PLC), an application specific integrated circuit, and other programmable circuits. Additionally, memory 183 of controller 177 may generally be or include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements.

The communication interface 179 enables the controller 177 to communicate with remote devices and systems, including the power delivery device 153. The communication interface 179 may be a wired or wireless communications interface that permits the controller to communicate with the remote devices and systems directly or via a network. Wireless communication interfaces may include a radio frequency (RF) transceiver, a Bluetooth® adapter, a Wi-Fi transceiver, a ZigBee® transceiver, an infrared (IR) transceiver, a near field communication (NFC) transceiver, and/or any other device and communication protocol for wireless communication. (Bluetooth is a registered trademark of Bluetooth Special Interest Group of Kirkland, Washington; ZigBee is a registered trademark of the ZigBee Alliance of San Ramon, California.) Wired communication interfaces may use any suitable wired communication protocol for direct communication including, without limitation, USB, RS232, I2C, SPI, analog, and proprietary I/O protocols. In some embodiments, the wired communication interface 169 may include a wired network adapter allowing the computing device to be coupled to a network, such as the Internet, a local area network (LAN), a wide area network (WAN), a mesh network, and/or any other network to communicate with remote devices and systems via the network. Although shown as a separate component, the communication interface 179 may be part of the controller 177 in some embodiments.

A user activated switch is communicatively connected to the motor controller 130 to provide a signal to the motor controller 130 to drive the motor 56 of the drain cleaner 10. In the example embodiment, the user activated switch is the foot operated switch 78. In other embodiments, any other suitable user activated switch may be used. In the example embodiment, when the motor controller 130 receives a command to drive the motor from the foot operated switch 78, the motor controller 130 instructs the power delivery device 153 (through the communication interfaces 179, 169) to provide power to the motor controller 130 (which may also be a command to drive the motor 56). The motor controller 130 drives the motor 56 using the power provided by the power delivery device 153. In some embodiments, the motor controller 130 drives the motor 56 using the power provided by the power delivery device 153 directly. Alternatively, the motor controller 130 converts the power provided by the power delivery device 152 to control the motor, such as by converting the DC power received from the power delivery device to a 3-phase output to power the motor 56. In other embodiments, the power delivery device also receives the signal from the foot operated switch 78 and provides power to the motor controller without the motor controller 130 needing to send instructions. In the example embodiments, the instruction(s) to drive the motor are continuous signals that are only instruct driving the motor so long as the signal is present. Thus, for example, when a user presses the switch 78, the signal is generated to instruct the motor controller 130 to drive the motor and the signal continues to be generated and transmitted to the motor controller 130 until the user stops pressing the switch 78. The motor controller drives the motor as long as the signal is received, and stops driving the motor when it no longer received the signal. In embodiments in which the motor controller commands the power delivery device to provide power to drive the motor, the motor controller 130 may similarly provide a continuous signal as long as the motor controller receives the signal from the switch 78. Alternatively, the motor controller 130 may send a first signal to command the power delivery device to provide power to drive the motor when it starts receiving the signal from the switch 78 and may send a second signal telling the power delivery device to stop providing power when it stops receiving the signal from the switch 78. In either configuration, the entire time that the power delivery device is commanded to provide power to the motor controller 130 is considered to be time when the power delivery device 153 is receiving an instruction to drive the motor.

The motor controller 130 is connected to the motor 56 through the rotary slip ring 142 and provide power from the power delivery device 153 to the motor 56 as needed.

The controller 167 of the power delivery device 153 is programmed to use the charging and switching circuitry 171 to control delivery of power the first power source or the second power source to the motor controller 130. The controller 167 is programmed to determine if the drain cleaner 10 is connected to the first power source. This determination may be made by looking for an expected voltage at the first input 161. If the voltage is present, the drain cleaner is connected to the first power source (e.g., the AC mains). If the expected voltage is not present, the controller 167 determines that the drain cleaner 10 is not connected to the first power source. In other embodiments, the determination may be made using other suitable techniques, such as receiving a separately generated signal indicating the drain cleaner is connected to the first power source, receiving an instruction from a remote device (such as the motor controller) that indicates the drain cleaner is connected to the first power source, or the like. The controller 167 also determines if the drain cleaner 10 is connected to the second power source (e.g., the battery 86). This determination may also be made by looking for an expected voltage at the second input 163. If the voltage is present, the drain cleaner is connected to the second power source, and if the expected voltage is not present, the controller 167 determines that the drain cleaner 10 is not connected to the second power source. In other embodiments, the determination may include additional or different techniques, such as receiving a separately generated signal indicating the drain cleaner is connected to the second power source, receiving an instruction from a remote device (such as the motor controller) that indicates the drain cleaner is connected to the second power source, receiving a temperature or other signal from the second power source, or the like. In some embodiments, the controller 167 checks an identification pin and an temperature pin as part of the determination of whether or not a battery is connected. The identification pin receives an identification signal of the battery when the battery is present and the temperature pin receives a temperature of the battery when the battery is present. The controller 167 receives an instruction to drive the motor. As explained above, the controller 167 may receive an instruction to drive the motor from the motor controller 130 or directly from the foot operated switch 78. The controller 167 uses the switching and charging circuitry 171 to deliver power from the first power source to the motor controller 130 through the first input 161 and the power output 165 while the instruction to drive the motor is received and the drain cleaner is connected to the first power source. The controller 167 uses the switching and charging circuitry 171 to deliver power from the second power source to the motor controller 130 through the second input 163 and the power output 165 while the instruction to drive the motor is received, the drain cleaner 10 is connected to the second power source, and the drain cleaner is not connected to the first power source. When the controller 167 is no longer receiving the instruction to drive the motor (whether no longer receiving a continuous signal or after receiving a stop signal), the controller 167 stops providing power from either power source to the motor controller 130.

The controller 167 also uses the power from the AC mains to selectively charge the battery 86. The controller 167 is programmed to use the switching and charging circuitry 171 to charge the battery 86 using power from the first input 161 output to the battery through the second input 163. Of course, the controller 167 can only perform this charging when the drain cleaner is connected to both the first power source and the second power source. If there is no battery 86 (second power source) present, the controller 167 does not attempt to charge the not present battery. Similarly, if the drain cleaner 10 is not connected to the first power source, there is no power available to charge the battery 86 and the controller does not attempt to do so. Some embodiments, additional or alternative criteria may be used when determining whether or not to charge the battery. For example, the controller 167 may also require that the identification pin and temperature pin discussed above have values within an expected and acceptable range before the battery will be charged. When the drain cleaner 10 is connected to both power sources, the controller 167 only charges the battery 86 when the motor 56 is not being driven. Overall, the controller 167 is programmed to use the switching and charging circuitry 171 to charge the battery 86 using power from the AC power source when the drain cleaner 10 is connected to the AC power source and the DC battery 86, the DC battery 86 is not fully charged, and the power delivery device 153 is not receiving an instruction to drive the motor.

The internal power supply 151, power delivery device 153, and motor controller 130 are stationary (do not rotate with the drum 38) and may be disposed in the front housing segment chamber 32 (FIG. 3). For the motor controller 130 to power the electric motor 56 which rotates with the drum 38, power is transferred through the rotary slip ring 142 (FIG. 10).

In some embodiments, the drain cleaner includes a temperature sensor 139 (FIG. 11). The temperature sensor 139 may be positioned within the inner drum chamber 53. In the illustrated embodiment, the temperature sensor 139 senses the temperature of the cable 61 (e.g., by sensing the temperature of the shield plate 94). As shown in FIG. 10, the temperature sensor 139 is connected to the motor controller 130 through the rotary slip ring 142.

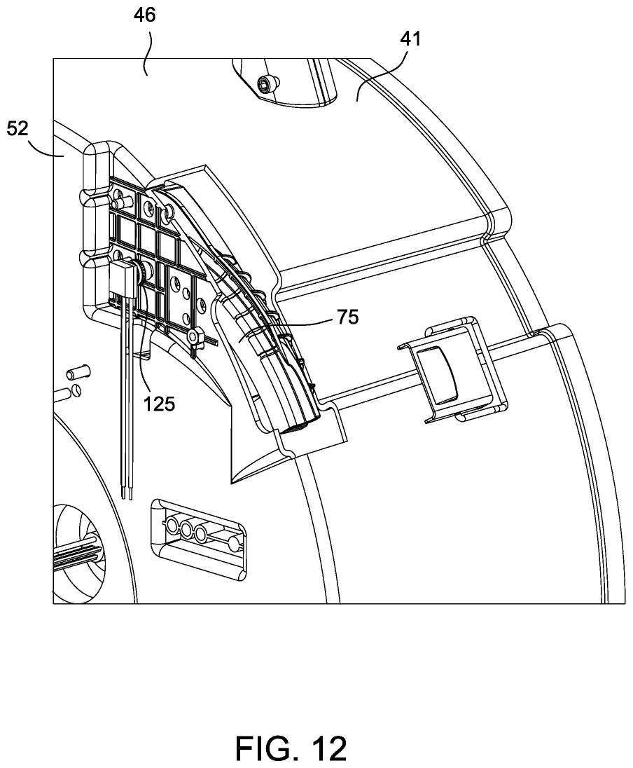

Alternatively or in addition, the drain cleaner 10 may include a position sensor 125 (FIG. 12) that senses the position of the cable clamp 75. The position sensor 125 is connected to the motor controller 130 through the rotary slip ring 142 (FIG. 10).

Compared to conventional high speed drain cleaners, the drain cleaners of embodiments of the present disclosure have several advantages. By using a stationary battery, the battery is more readily accessible by an operator in the field. A removable cover encloses the battery compartment which keeps debris from contacting the battery while providing access to the battery. The battery is secured within the battery compartment by rails which allow the battery to be easily removed and repositioned within the battery compartment. The rotary slip ring allows power to be transferred from the stationary battery or power cord (e.g., through the internal power supply) to the motor which rotates with the drum. The rotary slip ring allows communication from various rotating sensors (e.g., temperature and/or position sensors) to the stationary controller. By positioning the battery outside of the drum, the drum system can remain contained and is not exposed to the environment and contaminants and debris. The inclusion of dual power sources and the power delivery device provides a more versatile machine than some known drain cleaners by providing a drain cleaner operable from AC mains power or from a DC battery when AC mains power is not available. Moreover, the drain cleaner charges the battery in the drain cleaner (i.e., without needing to remove the battery) when the battery and AC power are both connected and the motor is not being driven, which improves the usability of the drain cleaner by keeping the battery charged and ready to use without needing to remove the battery for charging as is needed in some known drain cleaners.

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

What is claimed is:

1. A power tool device comprising:
a motor;
a motor driver circuit coupled to the motor and configured to drive the motor with received power; and
a power delivery device coupled to the motor driver circuit, the power delivery device including:
a first input to receive power when the power tool is connected to a first power source;
a second input to receive power when the power tool is connected to a second power source;
a power output coupled to the motor driver circuit to selectively deliver power to the motor driver circuit; and
a controller programmed to:
determine if the power tool is connected to the first power source;
determine if the power tool is connected to the second power source;
receive an instruction to drive the motor;
deliver power from the first power source to the motor driver circuit through the first input and the power output while the instruction to drive the motor is received and the power tool is connected to the first power source; and
deliver power from the second power source to the motor driver circuit through the second input and the power output while the instruction to drive the motor is received, the power tool is connected to the second power source, and the power tool is not connected to the first power source.

2. The power tool device of claim 1, wherein the first power source comprises an alternating current (AC) power source connectable to the power tool by a power cord, and the second power source comprises a rechargeable direct current (DC) battery removably attachable to the power tool.

3. The power tool of claim 2, further comprising an AC to DC converter having an input to receive power from the AC power source and an output to provide a DC output to the first input of the power delivery device.

4. The power tool of claim 2, wherein the power delivery device further comprises a battery charging circuit, and the controller is further programmed to use the battery charging circuit to charge the DC battery using power from the AC power source when the power tool is connected to the AC power source and the DC battery, the DC battery is not fully charged, and the power delivery device is not receiving an instruction to drive the motor.

5. The power tool of claim 4, wherein the controller uses the battery charging circuit to charge the DC battery through the second input.

6. The power tool of claim 1, wherein the motor driver circuit includes a first communication interface, the power delivery device includes a second communication interface connected to the motor driver circuit's first communication interface, and the instruction to drive the motor comprises a signal communicated from the motor driver circuit to the power delivery device using the first communication interface and the second communication interface.

7. The power tool of claim 1, wherein the power tool device includes a user activatable switch, and the instruction to drive the motor comprises a signal from the user activatable switch.

8. A method of operating a power tool including a motor, the method comprising:
determining if the power tool is connected to a first power source;
determining if the power tool is connected to a second power source;
determining if an instruction to drive the motor is being received;
powering the motor from the first power source when the instruction to drive the motor is being received and the power tool is connected to the first power source; and
powering the motor from the second power source when the instruction to drive the motor is being received, the power tool is connected to the second power source, and the power tool is not connected to the first power source.

9. The method of claim 8, wherein the first power source comprises an alternating current (AC) power source connectable to the power tool by a power cord, and the second power source comprises a rechargeable direct current (DC) battery removably attachable to the power tool.

10. The method of claim 9, further comprising converting AC power from the AC power source to DC power when the power tool is connected to the AC power source.

11. The method of claim 9, further comprising charging the DC battery using power from the AC power source when the power tool is connected to the AC power source and the DC battery, the DC battery is not fully charged, and an instruction to drive the motor is not being received.

12. The method of claim 9, wherein determining if an instruction to drive the motor is being received comprises determining if an instruction to drive the motor is received from a motor driver circuit through a communication interface.

13. The power tool of claim 1, wherein determining if an instruction to drive the motor is being received comprises determining if an instruction to drive the motor is received from a user activatable switch.

14. A drain cleaner comprising:
a housing;
a rotatable drum disposed in the housing;
a motor secured to the drum for rotating a drain cleaning cable, the motor being rotatable with the drum;
a motor driver circuit coupled to the motor and configured to drive the motor with received power; and
a power delivery device coupled to the motor driver circuit, the power delivery device including:
a first input to receive power when the drain cleaner is connected to a first power source;
a second input to receive power when the drain cleaner is connected to a second power source;
a power output coupled to the motor driver circuit to selectively deliver power to the motor driver circuit; and
a controller programmed to:
determine if the drain cleaner is connected to the first power source;
determine if the drain cleaner is connected to the second power source;
receive an instruction to drive the motor;
deliver power from the first power source to the motor driver circuit through the first input and the power output while the instruction to drive the motor is received and the drain cleaner is connected to the first power source; and
deliver power from the second power source to the motor driver circuit through the second input and the power output while the instruction to drive the motor is received, the drain cleaner is connected to the second power source, and the drain cleaner is not connected to the first power source.

15. The drain cleaner of claim 14, wherein the first power source comprises an alternating current (AC) power source connectable to the drain cleaner by a power cord, and the second power source comprises a rechargeable direct current (DC) battery removably attachable to the drain cleaner.

16. The drain cleaner of claim 15, further comprising an AC to DC converter having an input to receive power from the AC power source and an output to provide a DC output to the first input of the power delivery device.

17. The drain cleaner of claim 15, wherein the power delivery device further comprises a battery charging circuit, and the controller is further programmed to use the battery charging circuit to charge the DC battery using power from the AC power source when the drain cleaner is connected to the AC power source and the DC battery, the DC battery is not fully charged, and the power delivery device is not receiving an instruction to drive the motor.

18. The drain cleaner of claim 17, wherein the controller uses the battery charging circuit to charge the DC battery through the second input.

19. The drain cleaner of claim 14, wherein the motor driver circuit includes a first communication interface, the power delivery device includes a second communication interface connected to the motor driver circuit's first communication interface, and the instruction to drive the motor comprises a signal communicated from the motor driver circuit to the power delivery device using the first communication interface and the second communication interface.

20. The drain cleaner of claim 14, wherein the drain cleaner includes a user activatable switch, and the instruction to drive the motor comprises a signal from the user activatable switch.
